(19) United States
(12) Patent Application Publication
(10) Pub. No.: US 2009/0047541 A1
(43) Pub. Date: Feb. 19, 2009

(54) Methods and Systems of Dielectric Film Materials For Use in Capacitors

(75) Inventor: M. Zafar Munshi, Missouri City, TX (US)

Correspondence Address: CONLEY ROSE, P.C.;David A. Rose, P. O. BOX 3267, HOUSTON, TX, 77253-3267, US

(73) Assignee: LITHIUM POWER TECHNOLOGIES, INC., Manvel, TX (US)

(21) Appl. No.: 11/839,049

(22) Filed: Aug. 15, 2007

(51) Int. Cl. B32B 15/08; B29C 67/00; C08K 3/26; C08K 3/36; C08L 25/06; C08L 27/16; C08L 81/06

(52) U.S. Cl. 428/626; 264/211.23; 264/484; 428/220; 524/425; 524/545; 525/185; 525/189; 525/199

(57) ABSTRACT

Methods and systems of dielectric film materials to be used in capacitors. At least some of the illustrative embodiments are dielectric materials in the form of polymer film comprising a blend of polyvinylidene fluoride (PVDF) and at least one selected from the group consisting of: polyethylene terephthalate (PET); polycarbonate (PC); polyethylene naphthalate (PEN); polyphenylene sulfide (PPS); polytetrafluoroethylene (PTFE); polystyrene (PST); polysulphone (PS); polyethermide (PEM); and polyimide (PI).

### BACKGROUND

A polymer film capacitor comprises two conducting metal sheets or films separated by an insulating media (dielectric) capable of storing electrical energy in the form of an electric field. In some cases, the metal sheets and dielectric media are separate components, and in other cases the metal sheets may be deposited directly to one or both sides of the dielectric material (e.g., wound metallized plastic film capacitor).

Capacitors having dielectric media in the form of a single constituent plastic (homopolymer) films have been the capacitor of choice for many power electronics and pulse power applications (e.g., films made of polypropylene (PP) or polyvinylidene fluoride (PVDF)). However, the various homopolymer films have advantages and disadvantages. For example, films made of homopolymer PVDF have high dielectric constant, but poor electrical properties which restrict their use in capacitors for most commercial applications. As another example, films made of homopolymer PP have high breakdown voltages and excellent electrical properties, but low dielectric constant and low maximum operating temperature. The following table provides some illustrative properties of capacitors with differing types of homopolymer dielectric material.

TABLE 1

| | | | | | Max. | |
|---|---|---|---|---|---|---|
| | | Dielectric | | Volume | Oper. | Energy |
| Capacitor Types | | Strength | DF | Resistivity | Temp. | Density |
| Plastic Film | K | (V/mil) | (%) | (Ohms · cm) | (° C.) | (J/cc) |
| Polycarbonate (PC) | 2.8 | 13,400 | <1 | 2 × 10¹⁷ | 125 | <1 |
| Polypropylene (PP) | 2.2 | 16,250 | <0.1 | 1 × 10¹⁸ | 105 | <1 |
| Polyethylene | 3.3 | 14,500 | <1.5 | 1 × 10¹⁷ | 125 | <1 |
| terephthalate (PET) | | | | | | |
| Polyvinylidene fluoride (PVDF) | 12 | 15,000 | 1-5 | 1 × 10¹⁵ | 105 | 2.4 |
| Polyethylene | 3.2 | 14,000 | <1 | 1 × 10¹⁷ | 125 | <1 |
| naphthalate (PEN) | | | | | | |
| Polyphenylene sulfide (PPS) | 3.0 | 14,000 | <0.2 | 5 × 10¹⁷ | 200 | <1 |
| Polyimide (PI) | 3.5 | 7,500 | <1 | 2 × 10¹⁷ | 300 | <1 |

Where K is the dielectric constant, and DF is dissipation factor. As shown in the table, the energy density for these capacitors is less than 1 Joule/cc in every case except using PVDF as the dielectric material.

U.S. Pat. No. 6,426,861 discusses blending film constituents based on the chemical/electrical structure of the individual constituents to obtain a resultant film with more advantages and fewer disadvantages. In particular, the '861 patent discusses that some homopolymers, such as PVDF, posses polar groups in the polymer chains. The polar groups tend to orient themselves in applied electric fields, and the orientation results in some desirable characteristics (e.g., high dielectric constant) and some undesirable characteristics (e.g., degraded high frequency response, and poor electrical properties). Other homopolymers, such as PP, do not possess polar groups and thus are not subject to polar group orientations in applied electric fields. According to the '861 patent, the lack of orientation of portions of the polymer chains in applied electric fields results in some desirable characteristics (e.g., good high frequency response). The '861 patent discussed blending a highly polar material, such as PVDF, with a non-polar material, such as PP, to form a new polymer film with advantages of both the polar and non-polar materials.

### BRIEF DESCRIPTION OF THE DRAWINGS

For a detailed description of exemplary embodiments of the invention, reference will now be made to the accompanying drawings in which:

FIG. 1 shows a capacitor in accordance with at least some embodiments;

FIG. 2 shows dielectric film material in accordance with at least some embodiments;

FIG. 3 shows an illustrative view of winding the dielectric film material around a mandrel; and

FIG. 4 shows a method in accordance with at least some embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .”

### DETAILED DESCRIPTION

The following discussion is directed to various embodiments. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

FIG. 1 illustrates a capacitor 10 in accordance with at least some embodiments. In particular, the capacitor 10 comprises a winding 12. The winding 12 comprises a dielectric material (discussed more below) between metallic layers. In some embodiments the dielectric material and metallic layers are wound, and in the illustrative case of FIG. 1, the dielectric material and metallic layers are wound into cylindrical form. Other shapes may be equivalently used, including capacitors where the dielectric material and metal layers are stacked, but not wound. Leads 14 and 16 couple to respective metallic layers, and protrude from the capacitor to enable coupling of the capacitor 10 within electrical circuits.

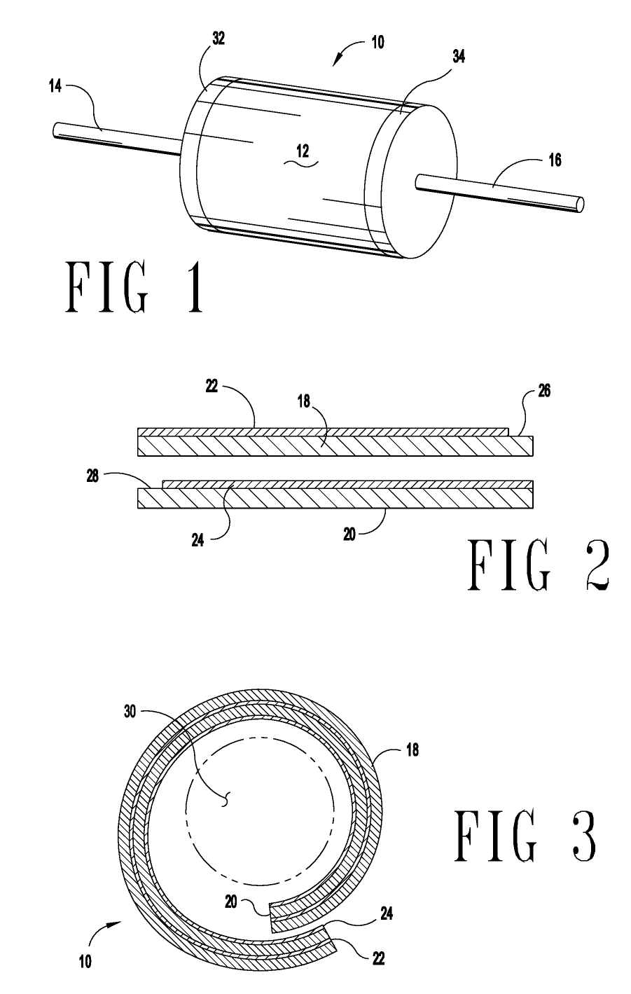

FIG. 2 illustrates a physical relationship between the dielectric material and metal layers in accordance with at least some embodiments. In particular, FIG. 2 illustrates dielectric film material 18 and 20. The constituents of the dielectric film material are discussed more fully below. In the embodiments illustrated by FIG. 2, each dielectric film material 18 and 20 is coated with a metal film 22 and 24, respectively. For example, the metal films 22, 24 may be applied to the dielectric film material 18, 20 by way of vapor deposition of metal (e.g., aluminum) in a vacuum chamber. In some embodiments, the metal films have a thickness of about 50 to about 500 Angstroms, but other thicknesses may be equivalently used. Before the metallization process is performed, the dielectric film material 18, 20 is appropriately masked to provide unmetallized margins, such as margins 26, 28 for films 18, 20 respectively.

FIG. 3 illustrates winding dielectric film material 18, 20 (with applied metal films 22, 24) around a mandrel 30 to make a wound capacitor 10. The mandrel could be in the form of a pin or a plastic core. In other embodiments a mandrel is not required and thus the films could be wound without a mandrel. Once wound, in order to ensure sufficient electrical contact between the leads 14, 16 and the metal films 22, 24, in some embodiments each end of the capacitor has applied thereto a metallic material (i.e., schooped), and the leads 14 and 16 are electrically coupled to the respective schooping material. The schooping is illustrated in FIG. 1 as schooping 32 and 34 for leads 14 and 16 respectively. The margins 26 and 28 (FIG. 2) ensure that the schooping material only contacts one of the “layers” of the capacitor 10 formed by the metal films 22, 24.

The capacitor discussed in FIGS. 1-3 is merely illustrative. Other capacitor configurations (e.g., stacked but flat, stacked and wound into shapes other than cylindrical) may be equivalently used. Moreover, while the metal films 22, 24 are discussed as being deposited on the dielectric film material, in other embodiments the metal films are individual films or sheets that are combined with dielectric film material to form the capacitor. In yet still other embodiments, the metal films and dielectric material may be placed in a hermetically sealed container and impregnated with a dielectric fluid. Attention now turns more specifically to constituent components of the dielectric film material.

In accordance with the various embodiments, the dielectric film material is a blend of two or more polymer materials. However, unlike U.S. Pat. No. 6,426,861 discussed in the Background, which patent discusses combining a polar material (e.g. PVDF) with a non-polar material (e.g. PP), the inventor of the present specification has found that combinations or blends of two or more polar materials surprisingly results in dielectric film material with desirable characteristics, such as high dielectric constant, high breakdown voltage, low dissipation factor, low leakage current, high operating temperatures, and the ability to be manufactured in thicknesses of 0.5 to 25 micrometers or microns (μm). In particular, the blends of polymer materials in accordance with the various embodiments are of at least two polar materials (e.g., one polar material having a high dielectric constant of at least 5 and a second polar material having temperature resistance properties exceeding that of polypropylene).

A number of new designs of dielectric film material are possible by choosing the initial materials and tailoring the blends for the intended application. For example, in the design and construction of a capacitor supporting about five or more Joules per cubic centimeter (J/cc) (e.g., for use in defibrillator applications), a material with a very high dielectric constant, good clearing ability and breakdown voltages combined with the ability to produce films in thicknesses of less than 2.5 μm would be desirable. An example of two polymers that could be blended to meet these criteria is PVDF (being highly polar) and PET (relatively polar), with specific percentages of the components dependent on the desired characteristics of the film capacitor in each particular instance. Representative samples are provided below. In the example of PVDF and PET, one theory for the reason the blend works well is that the highly polar activity of PVDF is reduced and stabilized through the formation of the polymer blend with relatively polar PET. The reduction in the polarization activity is reflected in the improvements in the electrical properties of the film, such as an increase in the breakdown voltage and insulation resistance of the blended polymer compared to PVDF alone, and the ability to be manufactured in ultra-thin films. The result is a material with enhanced energy density and electrical stability over PVDF polymer alone.

Blending PVDF and PET is merely illustrative, as the various embodiments are directed to blending any two or more polar polymers to produce a dielectric film material. For example, depending on the desired properties of the dielectric film material, a highly polar polymer such as PVDF could be blended with one or more of the following to produce dielectric film material: polyethylene terephthalate (PET); polycarbonate (PC); polyethylene naphthalate (PEN); polyphenylene sulfide (PPS); polytetrafluoroethylene (PTFE); polystyrene (PST); polysulphone (PS); polyethermide (PEM); and polyimide (PI). In the illustrative case of blending PVDF and PET, the ratios of PVDF to PET may range from about 0.01(1%):0.99(99%) PVDF:PET to 0.99(99%):0.01(1%) PVDF:PET. Similar ratios may be operable for the other illustrative polymers.

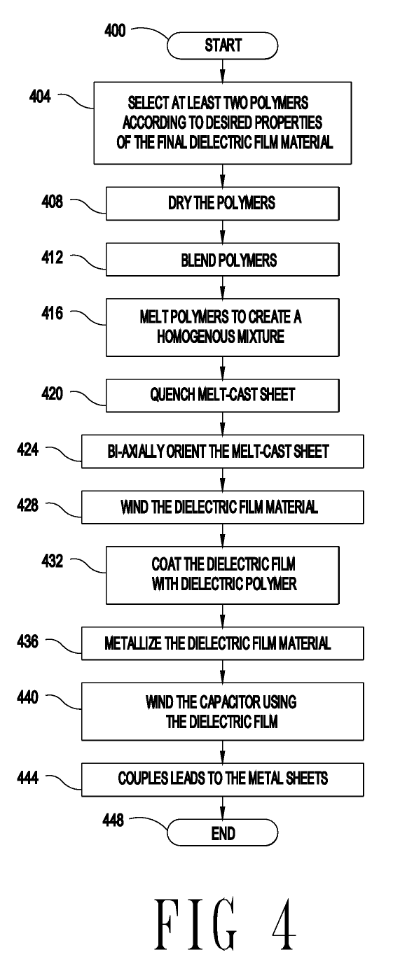

Constructing a dielectric film material and/or a capacitor with the dielectric film material in accordance with the various embodiments is a multi-step process, with many alternatives, and an illustrative construction is discussed with respect to FIG. 4. In particular, the method starts (block 400) and proceeds to selecting at least two polymers according to desired properties of the final dielectric film material (block 404). A non-limiting list of properties which may be considered when selecting the polymers is: dielectric constant; dielectric strength; insulation resistance; physical strength; and operating temperature. A secondary consideration with the respect to selecting polymers may be based on characteristics of the polymers in relation to physical characteristics of the polymers themselves, such as melting point and/or viscosity of the polymers in liquid or molten form. In some embodiments it is desirable that the polymers selected for the blend have melting points in close proximity to ensure a substantially homogeneous blend (e.g., the polymers having melting points within 75-100 Degrees Celsius of each other). Moreover, once in a liquid state polymers having significantly different fluid viscosities may not mix well, and thus in other embodiments it is desirable that the polymers selected for the blend have fluid viscosities in close proximity (e.g., polymers having fluid viscosities within 1000 to 10,000 Pascal-seconds). Still referring to FIG. 4, after selecting the constituent polymers, the constituent polymers (in solid form) are dried (block 408) by being held at a temperature less than the melting points of the polymers, but high enough to drive off moisture (e.g., in the case of PVDF and PET, the solid form constituent components may be dried overnight at approximately 80 Degrees Celsius).

Once selected and dried, the constituent components are blended in solid form (block 412). Blending may take many forms. In some embodiments, the constituent polymers in solid, pellet form are blended, such as by feeding the individual polymers through separate feed ports into a mixing chamber, or twin-screw extruder consisting of intertwining feeding screws. In other embodiments, the blending may take place by constituent polymers in solid, pellet form being fed directly to a single-screw extruder through separate feed ports. In yet still other embodiments, the constituent components may be ground to a powder form, and blended in powder form before being melted together. Before proceeding, it is noted that other components may be included with the blended polymers. For example, to reduce sticking of the blended polymer to various rollers during subsequent processing, various release agents or additives may be included (e.g., silica or calcium carbonate).

After blending, the blended materials are melted to create a homogenous mixture by raising their temperature above the melting points of the constituent components (block 416). For “batch-type” operations, and in some embodiments, raising temperature may take place in a heated press. In the illustrative case of PVDF and PET, the blended polymers (in powder form) may be hot-pressed for approximately five seconds between steel plates at 280 to 300 Degrees Celsius at a pressure of approximately 20 tons. For “continuous” operations, the melting of the blended materials may take place by way of an extruder. Commercial scale production of dielectric film material is by way of the extruder, and thus the balance of the discussion is directed to methods associated with extrusion; however, the discussion with respect to extrusion should not be construed as limiting the various embodiments to just extrusion methods.

Still referring to FIG. 4, in the case of melting the constituent components by way of an extruder (again block 416), the blended materials are simultaneously heated and forced through an opening or slot die (i.e., extruded) to produce a continuous melt-cast sheet. In some embodiments, the blending of the polymers and extrusion takes place substantially simultaneously (e.g., a co-extrusion using a twin screw arrangement, where each constituent is fed from a separate hopper), and in other embodiments the polymers are blended prior to being applied to the extruder. It is noted that twin-screw arrangements that tend to shear the polymers as it travels through the extruder appear to result in a better final dielectric film material; however, shearing by the feed screws in not strictly required. In yet still other embodiments, the blended polymers could be melt-formed into homogeneous pellets separate and apart from the melt-cast sheet extrusion process, and thereafter fed as a single blended polymer for extrusion into a melt-cast sheet. Operating conditions of the extrusion process, such as feed throughput, individual extruder zone temperatures, extruder pressure, the torque on the feed screws, screw speed, length of extruder, shearing of polymers within the extruder at specific zones, and die opening and width may be adjusted to achieve a high quality melt-cast sheet. The operating conditions will vary for each composition even if the resin materials are the same.

The extrusion temperature and the throughput of the individual resin will vary depending upon the composition, and the die opening and width will depend upon the desired thickness and width of the final film. The parameters are varied to achieve a melt-cast sheet thickness in a range from about 25 to 200 μm so as to achieve a final film thickness of about 0.5 to 25 μm at the end of the processing run, and a width in a range from about 20 inches to as wide as 400 inches. The wide range of variation is because each polymer will stretch and thin differently, and processing at various stages is adjusted to obtain the film desired without breaking, wrinkling, or overheating of the film web, for manufacture at the desired rate.

Still referring to FIG. 4, in some embodiments the melt-cast sheet produced by the extrusion process is quenched (block 420). Quenching may take many forms. In some embodiments, before the melt-cast sheet contacts further processing wheels or rollers, the melt-cast sheet is quenched by a rapid air-cooled jet impinging on the melt-cast sheet. In addition to, or in place of, the air-cooled quenching, the melt-cast sheet may be electrostatically pinned to a chill-wheel, where the chill-wheel is cooled using any appropriate system (e.g., chilled water or a refrigerant cycle). Quenching temperature of the chill-wheel, chill-wheel speed, electrostatic pinning of the film to the chill-wheel, and thickness of melt-cast sheet applied to the quenching may be adjusted until a good quality melt-cast sheet is obtained. In some embodiments, the melt-cast sheet as applied to the chill-wheel has a thickness of about 25 to 200 μm, and a width of about 20 to 30 inches.

The melt-cast film is then bi-axially oriented (block 424) to create an oriented film. In some embodiments, a two-step sequential method of bi-axially orientation involves stretching the melt-cast sheet first in the machine direction (i.e., machine direction orientation (MDO)) and then stretching the (partially) oriented film in the transverse direction (i.e., transverse direction orientation (TDO)). In other embodiments, the bi-axial orientation takes place by a melt-blown process or simultaneously stretching the film. Equipment to facilitate simultaneous bi-axial orientation may be acquired from Brückner Maschinenbau GmbH & Co. KG, Königsberger Str. 5-7 83313 Siegsdorf, Germany. Most commercial scale production of dielectric film material uses sequential bi-axial orientation, and thus the balance of the discussion is directed to such methods; however, the discussion with respect to sequential bi-axial orientation should not be construed as limiting the various embodiments to just sequential bi-axial orientation.

With respect to the illustrative sequential bi-axial orientation, the melt-cast sheet or dielectric film material is first pulled along through several rollers under tension into a MDO heated chamber where the dielectric film material is stretched, thus becoming a oriented film (though only in one direction after only MDO). In some embodiments, the dielectric film material exits the MDO chamber with a film thickness in a range from about 5 to 50 μm. The MDO chamber is a heated chamber comprising a series of rollers and tension control system that stretches the dielectric film material in the direction of travel to produce a thin film with a more uniform thickness. The process parameters in the MDO chamber are adjustable to control conditions such as line speed, film tension, and stretching ratios for desired film quality and thickness.

Still with respect to the illustrative sequential bi-axial orientation, after MDO the oriented film enters a TDO chamber where the film material is stretched in the transverse direction (e.g., by the tenter method). In particular, the film material is seized by a continuous series of mechanical jaws at both edges of the film width just before the film enters the TDO chamber. As the dielectric film material moves forward in the heated TDO chamber, the mechanical jaws move outward and thereby stretch the film to make it thinner and wider (e.g., to a final thickness in a range from about 0.5 to 25 μm and a width in a range from about 20 to 400 inches). In some embodiments, the film material is annealed (i.e., heated) in the TDO chamber before exiting the TDO chamber. At the opposite (i.e., exit) end of the TDO chamber, the jaws release the dielectric film material for winding. The process parameters in the TDO chamber are adjustable to control conditions such as line speed, film tension, and stretching ratios for desired film quality and thickness.

Still referring to FIG. 4, the next step in the illustrative process is winding the dielectric film material (block 428), such winding onto paper or plastic cores. In some embodiments, prior to winding, the edges of the dielectric film material are trimmed (e.g., those portions of the dielectric film material that were held by the jaws in the illustrative TDO process and may thus have non-uniform thickness). In the case of “batch” type processing, and in some cases “continuous” processing by way of extrusion, the winding of block 428 may be omitted.

The dielectric film material can then be processed further, if desired, to improve its electrical properties, at the same or at another processing facility. In some embodiments, the dielectric film material is coated with dielectric polymer (block 432) to enhance the film properties, such as sealing defects in the film and/or hardening the surface. In particular, the dielectric film material may be coated with acrylate as a single but continuous step to a thickness in a range from about 0.1 to 2.0 μm, and in some embodiments the coating has a high dielectric constant (e.g., 2.5 to 16). Such a coating may be applied either through casting an acrylate solution directly onto the film and curing the acrylate using electron beam or ultraviolet radiation, or depositing the acrylate via a spray or atomization method followed by such curing.

Still referring to FIG. 4, in embodiments where the metal film is not a separate sheet of material (e.g., for use in film-foil capacitors), the dielectric film material is then metallized (block 436), for example by spraying a metal (e.g., aluminum) onto the film via vapor deposition in a vacuum chamber. In some embodiments, the thickness of the metallization is from about 50 to about 500 Angstroms, and the resistivity of the metallization is from about 0.1 ohm per square to 1000 ohms per square. It is noted that the higher the resistance or conversely the lower the metal thickness, the better the breakdown voltage of the film dielectric. In at least some embodiments where the dielectric film material is metallized, before the metallization process is performed the film is masked to provide unmetallized margins (see, e.g., FIG. 2, regions 26 and 28).

Finally, two separate rolls of the dielectric film material (and if the dielectric film material is not metallized, separate metal foils rolls) are placed in a capacitor winder and wound (block 440) tightly together on a mandrel 30 (FIG. 1) (which mandrel may subsequently be removed) so that the layers are arranged in the sequence dielectric 18/metallized portion 22/dielectric 20/metallized portion 24, as best shown in FIG. 3. Thereafter leads 14, 16 are connected to respective metal sheets (block 444), and the illustrative method ends (block 448). As discussed above, the leads may be coupled to schooping material that substantially covers the ends of the capacitor 10, or the leads may electrically couple to tabs of metal sheets, or a combination of both.

### REPRESENTATIVE EXAMPLE 1

A PVDF homopolymer resin ground into a powder was combined with PET homopolymer resin ground also into a powder, and the powders were mixed homogeneously in weight percentage concentration ratio of 05:95 PVDF:PET. The mixed powders were hot-pressed for 5 seconds between lapped and polished steel plates at 280-300° C. and a pressure of 20 tons and quenched on a cooled surface. The resultant hybrid polymer sheet thicknesses for the 05:95 PVDF:PET was 48 μm. The dielectric constant of the film was measured on metallized samples using an LCR meter, while the breakdown voltage of the film was measured on plain film using a 60 kV DC power supply. The dielectric constant was 4.35. The dielectric constant at 120 Hz, 1 kHz, and 10 kHz was measured to be 4.39, 4.35 and 4.33, respectively. The breakdown voltage was 575 V/μm, and the intrinsic energy density at breakdown was determined to be 6.37 J/cc.

### REPRESENTATIVE EXAMPLE 2

A PVDF homopolymer resin ground into a powder was combined with PET homopolymer resin ground also into a powder, and the powders were mixed homogeneously in weight percentage concentration ratio of 10:90 PVDF:PET. The mixed powders were hot-pressed for 5 seconds between lapped and polished steel plates at 280-300° C. and a pressure of 20 tons and quenched on a cooled surface. The resultant hybrid polymer sheet thicknesses was 55 μm. The dielectric constant of the film was measured on metallized samples using an LCR meter, while the breakdown voltage of the film was measured on plain film using a 60 kV DC power supply. The dielectric constant was 5.52. The dielectric constant at 120 Hz, 1 kHz, and 10 kHz was measured to be 5.61, 5.52 and 5.46, respectively. The breakdown voltage was 540 V/μm, and the intrinsic energy density at breakdown was determined to be 7.13 J/cc.

### REPRESENTATIVE EXAMPLE 3

A PVDF homopolymer resin and PET homopolymer resin were fed separately into a Leistritz twin screw extruder at feed rates that delivered a composition of the final melt-cast blend sheet to be 95:05 PET:PVDF. Polymer sheets in thicknesses ranging from 55 μm to 125 μm were collected on an auxiliary roll. The thinnest uniform sections were analyzed as in Examples 1 and 2. A uniform film area of 63 μm was selected that resulted in a dielectric constant of 4.76. The dielectric constant at 120 Hz, 1 kHz, and 10 kHz was measured to be 4.83, 4.76 and 4.69, respectively. The breakdown voltage averaged 582 V/μm and the intrinsic energy density of the film at breakdown was determined to be 7.14 J/cc.

### REPRESENTATIVE EXAMPLE 4

Small sections of films from Example 3 were biaxially stretched using a Bruckner lab stretcher in the ratio 2.5×2.5 to produce films of thickness 16 μm. The final film was analyzed as in Examples 1 and 2. The dielectric constant of the film was 4.43. The dielectric constant at 120 Hz, 1 kHz, and 10 kHz was measured to be 4.48, 4.43 and 4.40, respectively. For the oriented film, the values for the dielectric constant over the range of frequencies measured were much closer. The breakdown voltage averaged at 578 V/μm. The intrinsic energy density of the film at breakdown was determined to be 6.55 J/cc.

In addition to high pulse power applications for capacitors in years past, new markets are evolving for capacitors with high energy density. For example, in the medical sector there is a need for capacitors for use in implantable and portable defibrillators for treatment of ventricular fibrillation and other cardiac dysrhythmias. A 30 J high voltage film capacitor using a dielectric film material as described herein could support an energy density of 6-8 J/cc, would occupy about 50% less volume than other types of capacitors, would have no reform or outgassing.

Another example of an evolving market is capacitors for hybrid electric vehicles. Hybrids vehicles use a boost converter in the electric drive system that raises the voltage provided from the battery to the inverter, thus enabling the inverter to drive a high power output motor. The boost converter/inverter comprises of a bank of capacitors. The role of these capacitors is to absorb the voltage variation during acceleration and deceleration. An ideal capacitor for use in hybrid vehicles would: be operable up to 700 volts; be operable in temperature of −40° C. to +125° C.; have 10-15 year life cycle; and have an energy density as high as possible. While the current capacitor of choice in hybrid electric vehicles, aluminum electrolytics, meets some of these requirements, such capacitors suffer from other shortcomings: contains liquid and is prone to leak; it is polarity sensitive meaning wrong connection may create toxic gas and explosion; series connection is required to attain the voltage; capacitor is not suitable for the required operating temperature of −40° C. to +125° C.; has poor longevity compared to the required 10-15 years; it is only available in cylindrical forms; and a short circuit could result in explosion. Capacitors made from a dielectric material as described herein could better meet some or all these requirements, particularly with respect to energy density and operating voltage.

The excellent properties of dielectric film material described herein extend to other compact energy storage applications such as lasers. Although the piezoelectric and pyroelectric properties of PVDF have long been known, wide scale commercial use of capacitors having PVDF as the dielectric film material has been limited by an unavailability of consistently stable and uniform thickness film with desirable electrical properties. The illustrative PVDF:PET polymer, or any other suitable combination, developed in accordance with the various embodiments provide improved stability, consistency and high levels of piezoelectric and pyroelectric activity, and is anticipated to be useful in loudspeakers, touch sensors, temperature sensors, ultrasonic ranging and imaging devices, and automobile bumper sensors, to name a few applications.

The above discussion is meant to be illustrative of the principles and various embodiments of the present invention. Numerous variations and modifications will become apparent to those skilled in the art once the above disclosure is fully appreciated. For example, the polymers to be blended need not be a single grade or a homopolymer. A PVDF resin could comprise different grades of one or more homopolymers or copolymers or a combination of homopolymers and copolymers, and yet still comprise the primary ingredient of a dielectric material. It is intended that the following claims be interpreted to embrace all such variations and modifications.

What is claimed is:

1. A dielectric material configured to be used in a capacitor, the dielectric material in the form of polymer film comprising a blend of polyvinylidene fluoride (PVDF) and at least one polar material selected from the group consisting of: polyethylene terephthalate (PET); polycarbonate (PC); polyethylene naphthalate (PEN); polyphenylene sulfide (PPS); polytetrafluoroethylene (PTFE); polystyrene (PST); polysulphone (PS); polyethermide (PEM); and polyimide (PI).

2. The dielectric material according to claim 1 wherein the polymer film is formed from a melt-cast blend.

3. The dielectric material according to claim 1 wherein the polymer film is biaxially oriented.

4. The dielectric material according to claim 1 wherein the polymer film is a blend of at least one selected from the group consisting of: homopolymers; copolymers; and homopolymers and copolymers.

5. The dielectric material according to claim 1 wherein the polymers of the blend have at least one selected from the group consisting of: melt-flow characteristics within about 100 Degrees C.; and viscosities within about 10,000 Pascal-Seconds.

6. The dielectric material according to claim 1 wherein the polymers of the blend have at least one selected from the group consisting of: melt-flow characteristics within about 75 Degrees C.; and viscosities within about 1000 Pascal-Seconds.

7. The dielectric material according to claim 1 further comprising a component to substantially prevent the dielectric material from sticking to film transporting rolls during film formation.

8. The dielectric material according to claim 7 wherein said component is at least one selected from the group consisting of: silica; and calcium carbonate.

9. The dielectric material according to claim 1 wherein the polymers of the blend are mixed in solid form, and extruded into melt-cast sheets.

10. The dielectric material according to claim 1 wherein the polymer film has a thickness in a range from about 0.5 to about 25 micro-meters.

11. The dielectric material according to claim 1 wherein the polymer film has a concentration of PVDF from about 0.01 (1%) to about 0.99 (99%).

12. The dielectric material according to claim 1 wherein the polymer film has a concentration of PVDF from between about 0.01 (1%) to about 0.30 (30%).

13. A method comprising extruding into melt-cast sheets a blend of polyvinylidene fluoride (PVDF) and a second polymer being at least one selected from the group consisting of: polyethylene terephthalate (PET); polycarbonate (PC); polyethylene naphthalate (PEN); polyphenylene sulfide (PPS); polytetrafluoroethylene (PTFE); polystyrene (PST); polysulphone (PS); polyethermide (PEM); and polyimide (PI).

14. The method according to claim 13 further comprising blending the PVDF and the second polymer in solid form.

15. The method according to claim 14 wherein blending further comprises feeding the PVDF and the second polymer by way of a twin-screw extruder.

16. The method according to claim 13 further comprising, prior to the extruding, drying the PVDF and the second polymer at a temperature less than the melting point of either the PVDF or the second polymer.

17. The method according to claim 13 further comprising quenching the melt-cast sheet.

18. The method according to claim 17 wherein quenching further comprises quenching using at least one selected from the group consisting of: a rapid air-cool jet impinging on the melt-cast sheet; and a liquid-cooled chill-wheel.

19. The method according to claim 13 further comprising:
electrostatically pinning the melt-cast sheet to a liquid-cooled chill-wheel; and
quenching the melt-cast sheet over a liquid-cooled chill-wheel.

20. The method according to claim 13 further comprising biaxially orienting the melt-cast sheet into an oriented film having a thickness from about 0.5 to about 25 micro-meters.

21. The method according to claim 20 wherein biaxially orienting further comprises:
performing a machine direction orientation (MDO); and
performing a transverse-direction orientation (TDO).

22. The method according to claim 21 wherein performing the MDO further comprises stretching melt-cast sheet from about 1.5 to about 15 times an original length.

23. The method according to claim 21 wherein performing the TDO further comprises stretching the melt-cast sheet from about 1.5 to about 15 times an original width.

24. The method according to claim 21 further comprising annealing the oriented film during performance of the TDO.

25. The method according to claim 13 wherein extruding further comprises extruding a blend of PVDF and the second polymer where the PVDF has a concentration about 0.01 (1%) to about 0.99 (99%).

26. The method according to claim 13 wherein extruding further comprises extruding a blend of PVDF and the second polymer where the PVDF has a concentration about 0.01 (1%) to about 0.30 (30%).

27. A film capacitor comprising:
a dielectric film comprising a blend of polyvinylidene fluoride (PVDF) and a second polymer selected from the group consisting of: polyethylene terephthalate (PET); polycarbonate (PC); polyethylene naphthalate (PEN); polyphenylene sulfide (PPS); polytetrafluoroethylene (PTFE); polystyrene (PST); polysulphone (PS); polyethermide (PEM); and polyimide (PI);
a first metal film abutting the dielectric film on a first side of the dielectric film;
a second metal film abutting the dielectric film on a second side of the dielectric film;
a first termination electrically coupled to the first metal film; and
a second termination electrically coupled to the second metal film.

28. The film capacitor according to claim 27 wherein the first metal film is deposited directly on the first side of the dielectric film.

29. The film capacitor according to claim 28 wherein the first metal film is deposited via a thermal deposition process.

30. The film capacitor according to claim 28 wherein depositing further comprises depositing a metal having an electrical resistance from about 0.1 ohms per square to about 1000 ohms per square.

31. The film capacitor according to claim 27 wherein the dielectric film has a concentration of PVDF from about 0.01 (1%) to about 0.99 (99%).

32. The film capacitor according to claim 27 wherein the dielectric film has a concentration of PVDF from between about 0.01 (1%) to about 0.30 (30%).

33. The film capacitor according to claim 27 wherein capacitor has at least one selected from the group consisting of: a wound configuration; and a stacked configuration.

34. The film capacitor according to claim 27 wherein the capacitor is impregnated with a dielectric fluid and hermetically sealed.

35. A method of manufacturing dielectric film comprising:
selecting at least two polymers according to a desired property of the dielectric film, the desired property being at least one selected from the group consisting of: dielectric constant; dielectric strength; insulation resistance; and operating temperature;
extruding a blend of the two polymers to create a melt-cast sheet; and
stretching the melt-cast sheet into an oriented film having a thickness from about 0.5 to about 25 micro-meters.

36. The method according to claim 35 further comprising blending the at least two polymers in solid form.

37. The method according to claim 35 further comprising coating the film with a polymeric material configured to at least one selected from the group consisting of: seal defects of the film; and harden a surface of the film.

38. The method according to claim 35 depositing a metal layer on a first side of the film.

39. The method according to claim 38 wherein depositing further comprises depositing a metal having an electrical resistance from about 0.1 ohms per square to about 1000 ohms per square.

40. The method according to claim 35 wherein selecting further comprises selecting polyvinylidene fluoride (PVDF) and at least one polymer selected from the group consisting of: polyethylene terephthalate (PET); polycarbonate (PC); polyethylene naphthalate (PEN); polyphenylene sulfide (PPS); polytetrafluoroethylene (PTFE); polystyrene (PST); polysulphone (PS); polyethermide (PEM); and polyimide (PI).
